(19) United States
(12) Patent Application Publication
(10) Pub. No.: US 2026/0343645 A1
(43) Pub. Date: Oct. 29, 2026

(54) DISTRIBUTED ACCESS POINT MULTI-LINK DEVICE

(71) Applicant: Nokia Technologies Oy, Espoo (FI)

(72) Inventors: Jianguo LIU, Shanghai (CN); Zhijie YANG, Shanghai (CN); Yan MENG, Shanghai (CN); Tao TAO, Shanghai (CN); Wenjian WANG, Shanghai (CN); Mika KASSLIN, Espoo (FI); Wenyi XU, Shanghai (CN); Orhan Okan MUTGAN, Munich (DE)

(21) Appl. No.: 19/110,245

(22) PCT Filed: Sep. 16, 2022
(86) PCT No.: PCT/CN2022/119484

§ 371 Date: Mar. 10, 2025

(51) Int. Cl. H04W 76/15; H04W 80/02; H04W 88/10

(52) U.S. Cl. CPC H04W 76/15; H04W 80/02; H04W 88/10

(57) ABSTRACT

Embodiments of the present disclosure relate to architecture of a distributed AP MLD. An apparatus comprises at least two upper MAC sublayer function entities and at least one middle MAC sublayer function entity configured to be affiliated by at least one AP that has a lower MAC sublayer function entity. The at least one middle MAC sublayer function entity is configured to communicate with the at least two upper MAC sublayer function entities through a logical port.

### FIELD

Embodiments of the present disclosure generally relate to the field of telecommunication and, in particular, to a distributed access point multi-link device (AP MLD).

### BACKGROUND

Multi-link operation (MLO) has been identified as an important feature of institute of electrical and electronics engineers (IEEE) 802.11be. MLO targets efficient operations in all the available bands, such as 2.4 GHz, 5 GHz, and 6 GHz, for load balancing, multi-band aggregation, and simultaneous downlink and uplink transmission. For MLO, an MLD manages communication over multiple links. Whether communication across different frequency bands or channels can occur simultaneously or not may depend on capabilities of both an AP MLD and a non-AP MLD.

### SUMMARY

Example embodiments of the present disclosure provide an improved solution for architecture of a distributed AP MLD.

In a first aspect, there is provided an apparatus. The apparatus comprises at least two upper MAC sublayer function entities and at least one middle MAC sublayer function entity configured to be affiliated by at least one AP that has a lower MAC sublayer function entity. The at least one middle MAC sublayer function entity is configured to communicate with the at least two upper MAC sublayer function entities through a logical port.

In a second aspect, there is provided an apparatus. The apparatus comprises: means for implementing at least two upper MAC sublayer function entities and means for implementing at least one middle MAC sublayer function entity configured to be affiliated by at least one AP that has a lower MAC sublayer function entity. The at least one middle MAC sublayer function entity is configured to communicate with the at least two upper MAC sublayer function entities through a logical port.

In a third aspect, there is provided a method. The method comprises: implementing at least two upper medium access control, MAC, sublayer function entities; and affiliating at least one middle MAC sublayer function entity with at least one access point, AP, that has a lower MAC sublayer function entity, wherein the at least one middle MAC sublayer function entity communicates with the at least two upper MAC sublayer function entities through a logical port.

In a fourth aspect, there is provided an apparatus. The apparatus comprises at least one processor and at least one memory storing instructions. The instructions, when executed by the at least one processor, cause the apparatus at least to: implement at least two upper medium access control, MAC, sublayer function entities; and affiliate at least one middle MAC sublayer function entity with at least one access point, AP, that has a lower MAC sublayer function entity, wherein the at least one middle MAC sublayer function entity communicates with the at least two upper MAC sublayer function entities through a logical port.

In a fifth aspect, there is provided a computer readable medium. The non-transitory computer readable medium comprises program instructions for causing an apparatus to perform the method according to the third aspect.

It is to be understood that the summary section is not intended to necessarily identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example implementations will now be described with reference to the accompanying drawings, where:

FIG. 1 illustrates an example of an MLO between an AP MLD and a non-AP MLD;

FIG. 2 illustrates a data plane architecture of a medium access control (MAC) layer of a legacy AP MLD;

FIG. 3 illustrates an example apparatus in accordance with some example implementations of the present disclosure;

FIG. 4 illustrates an example of data plane architecture of a MAC layer for a distributed AP MLD in accordance with some example implementations of the present disclosure;

FIG. 5 illustrates an example of MLO between a distributed AP MLD in accordance with some example implementations of the present disclosure and a non-AP MLD;

FIG. 6 illustrates a simplified block diagram of an apparatus that is suitable for implementing example implementations of the present disclosure; and

FIG. 7 illustrates a block diagram of an example computer readable medium in accordance with example implementations of the present disclosure.

Throughout the drawings, the same or similar reference numerals represent the same or similar element, unless otherwise provided.

### DETAILED DESCRIPTION

Principles of the present disclosure will now be described with reference to some example implementations. It is to be understood that these implementations are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, but not limited to, fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the JAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

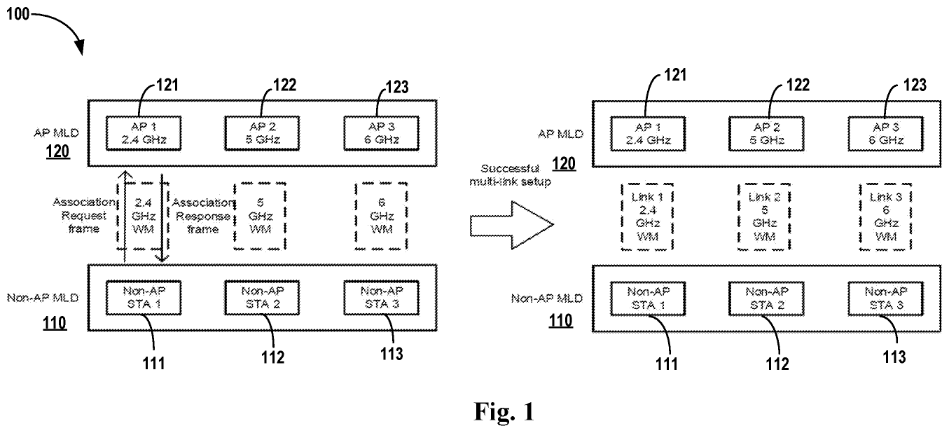

FIG. 1 illustrates an example 100 of an MLO between an AP MLD 120 and a non-AP MLD 110. As shown in FIG. 1, the non-AP MLD 110 has affiliated non-AP stations (STAs) 111, 112 and 113. Hereinafter, a non-AP STA is also referred to as STA for brevity. The AP MLD 120 has affiliated APs 121, 122 and 123.

The AP 121 operates on 2.4 GHz band, the AP 122 operates on 5 GHz band, and the AP 123 operates on 6 GHz band. Three links on 2.4 GHz, 5 GHz and 6 GHz bands can be established for simultaneous communication between the AP MLD 120 and the non-AP MLD 110 after MLD setup or MLD re-setup.

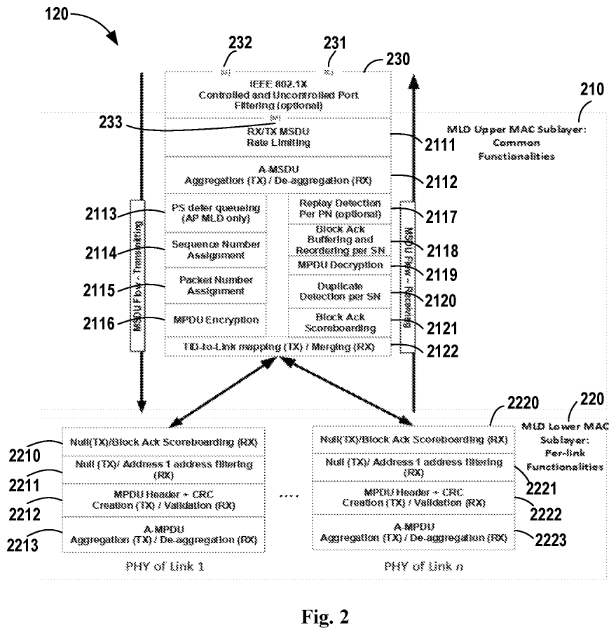

FIG. 2 illustrates a data plane architecture of a medium access control (MAC) layer of the legacy AP MLD 120 with n links for unicast data frames. N is an integer which is equal to or greater than two.

As shown in FIG. 2, the AP MLD 120 comprises an IEEE 802.1X controlled and uncontrolled port filtering port 230 and a MAC layer. For MLO, the MAC layer of the AP MLD 120 can be divided into an MLD upper MAC sublayer 210 and two MLD lower MAC sublayers 220.

The IEEE 802.1X controlled and uncontrolled port 230 comprises an IEEE 802.1X controlled port (C) 231 and an IEEE 802.1X uncontrolled port (U) 232. The IEEE 802.1X controlled port 231 is blocked from passing general data traffic between two STAs or between two MLDs until an IEEE 802.1X authentication procedure completes successfully over the IEEE 802.1X uncontrolled port 232. If the IEEE 802.1X controlled port 231 is not enabled and if a received MAC service data unit (MSDU) does not represent an IEEE 802.1X frame, the IEEE 802.1X controlled port 231 discards the received MSDU.

The IEEE 802.1X controlled and uncontrolled port 230 communicates with the MLD upper MAC sublayer 210 through a single MAC service access point (MAC-SAP) 233.

The MLD upper MAC sublayer 210 performs functionalities that are common across all the links. The MLD lower MAC sublayers 220 perform functionalities that are local to each link. Some of the functionalities require joint processing of both the MLD upper MAC sublayer 210 and the MLD lower MAC sublayers 220.

Specifically, the MLD upper MAC sublayer 210 comprises an RX/TX MSDU rate limiting block 2111, an A-MSDU aggregation or de-aggregation block 2112, a PS defer queueing block 2113, a sequence number (SN) assignment block 2114, a packet number (PN) assignment block 2115, a MAC packet data unit (MPDU) encryption block 2116, a replay detection block 2117, a block acknowledgment (Ack) buffering and reordering block 2118, an MPDU decryption block 2119, a duplicate detection block 2120, a block Ack scoreboarding block 2121 and a traffic identifier (TID)-to-link mapping or merging block 2122.

The RX/TX MSDU rate limiting block 2111 is configured to enforce the resource utilization limit in a certain rate.

The A-MSDU aggregation or de-aggregation block 2112 is configured to allow several MAC-level service data units (MSDUs) to be aggregated into a single MPDU, or allow a single MPDU to be de-aggregated into several MSDUs.

The PS defer queueing block 2113 is configured to defer and buffer an MPDU transmission for power saving reasons, which implies that the MPDU is assigned to a link in the upper MAC 210 and is then buffered until the power saving state of that link is good to transmit the MPDU.

The SN assignment block 2114 is configured to perform SN assignment for frames to be encrypted by pairwise transient key (PTK) for unicast frames.

The PN assignment block 2115 is configured to perform PN assignment for frames to be encrypted by PTK for unicast frames.

The MPDU encryption block 2116 is configured to perform encryption using PTK for unicast frames.

The replay detection block 2117 is configured to detect a replay transmission from attacker which monitors transmissions (passive attack) and retransmits messages posing as the legitimate user.

The block Ack buffering and reordering block 2118 is configured to perform reordering of packets to ensure in-order delivery per each Block Ack session.

The MPDU decryption block 2119 is configured to perform decryption using PTK for unicast frames.

Where MAC-level acknowledgments and retransmissions are incorporated into the protocol, there is the possibility that a frame may be received more than once. The duplicate detection block 2120 is configured to attempt to filter out the duplicate frame receiving.

The block Ack scoreboarding block 2121 is configured to perform block Ack scoreboarding for individually addressed frames in collaboration with the MLD lower MAC sublayers 220. Optionally, the MLD upper MAC sublayer 210 delivers the Block Ack record on one link to the MLD lower MAC sublayer of the other link.

In IEEE 802.11be specification, the TID-to-link mapping mechanism allows the AP MLD 120 and the non-AP MLD 110 that perform multi-link setup to determine how the TIDs are mapped to the setup links in DL and UL. If a link is defined as a disabled link, and then no TID will map to that link in both DL and UL, and thus the AP MLD 120 can dynamically manage the traffic delivered link for a special non-AP MLD according to the traffic scheduling strategy.

The TID-to-link mapping or merging block 2122 is configured to perform selection of one of the MLD lower MAC sublayers 220 for transmission or perform merging of MPDUs from the selected MLD lower MAC sublayer.

Specifically, the MLD lower MAC sublayers 220 comprise the following blocks which are associated with a link 1: a block Ack scoreboarding block 2210, an address filing block 2211, an MPDU header and CRC creation or validation block 2212 and an A-MSDU aggregation or de-aggregation block 2213.

The block Ack scoreboarding block 2210 is configured to perform block Ack scoreboarding for individually addressed frames in collaboration with the block Ack scoreboarding block 2121 in the MLD upper MAC sublayer 210. Optionally, the block Ack scoreboarding block 2210 is configured to receive from the Block Ack record on the other links from the MLD upper MAC sublayer 210.

The address filing block 2211 is configured to perform a MAC address filtering for frame reception.

The MPDU header and CRC creation or validation block 2212 is configured to create or validate an MPDU header and CRC.

The A-MSDU aggregation or de-aggregation block 2213 is configured to allow several MSDUs to be aggregated into a single MPDU, or allow a single MPDU to be de-aggregated into several MSDUs.

Control plane functions of the MLD lower MAC sublayers may comprise at least one of the following:
maintenance of link specific GTK/IGTK/BIGTK between an AP affiliated with the AP MLD 120 and an STA affiliated with the non-AP MLD 110;
link-specific encryption/decryption/integrity protection and PN assignment using GTK/IGTK/BIGTK between an AP affiliated with the AP MLD 120 and a STA affiliated with the non-AP MLD 110;
link specific management information (such as beacon) exchange/indication;
link specific control information (such as RTS/CTS, acknowledgements, NDP) exchange/indication; or
control of power save state and mode.

Similarly, the MLD lower MAC sublayers 220 comprise the following blocks which are associated with a link n: a block Ack scoreboarding block 2220, an address filing block 2221, an MPDU header and CRC creation or validation block 2222 and an A-MSDU aggregation or de-aggregation block 2223. The functions of the blocks 2220 to 2223 are the same as those of the blocks 2210 to 2213.

During transmission, MSDUs from the MAC-SAP 233 go through the processes shown in the left-hand side of FIG. 2, then through the TID-to-link mapping process in the TID-to-link mapping or merging block 2122. The TID-to-link mapping or merging block 2122 forwards the MPDUs down to one of the MLD lower MAC sublayers and then to the corresponding PHY SAP (not shown in FIG. 2).

During reception, MPDUs originating from different PHY SAPs first go through an MLD lower MAC sublayer, followed by a merging process in the TID-to-link mapping or merging block 2122. Then, the MPDUs go through the process in the right-hand side of FIG. 2. Then, one or more MSDUs are delivered to the MAC-SAP 233 or via a distribution system access function (DSAF) to a distributed system (DS).

When MLO is being used, the same pairwise transient key security association (PTKSA) is used to encrypt unicast MPDUs and MAC management protocol data units (MMPDUs) prior to transmission on the links. The same PTKSA is used to decrypt the unicast MPDUs and MMPDUs received on the links. The group temporal key (GTK) of a link is used to encrypt the group addressed frames MPDUs and MMPDUs prior to transmission on the link. The GTK of a link is used to decrypt the group addressed frames MPDUs and MMPDUs received on the link.

When MLO is being used, the block Ack scoreboarding block 2121 in the MLD upper MAC sublayer 210 manages the Block Ack status of the MPDUs (of this Block Ack session) that are received on any setup link. Each of the block Ack scoreboarding block 2210 and 2220 in the MLD lower MAC sublayer 220 manages the block Ack status of the MPDUs of this block Ack session that are received on this link. Each of the block Ack scoreboarding blocks 2210 and 2220 may convey block Ack status of the MPDUs received on another link if it obtained such information from the other link via the MLD upper MAC sublayer 210.

For MLO, the following open issues still need to be addressed.

First, a service interruption issue would occur during fast basic service set (BSS) transition procedure among AP MLDs as one non-AP MLD is not allowed to associate with two AP MLDs at the same time according to the latest IEEE 802.11be specification. For example, when a non-AP MLD, such as a Wi-Fi 7 cell phone, moves far away from its associated AP MLD and near to a neighbour AP MLD, the non-AP MLD may disconnect the association with the current AP MLD and re-associate with the neighbour AP MLD according to the rule defined by IEEE 802.11be latest draft. In this case, the service interruption issue may happen and cause low latency service (e.g., AR, VR, XR and so on) break issue, which is not a friendly design to the terminal device.

Second, typically, a collocated AP MLD may only have three links operating on the three unlicensed bands accordingly. For example, the AP 121, AP 122 and AP 123 affiliated with the AP MLD 120 operate on 2.4 GHz band, 5 GHz band and 6 GHz band, respectively. It is very hard to have more links due to intra-band interference issue. This may cause the collocated AP 121, AP 122 and AP 123 affiliated with the AP MLD 120 to interfere with each other if the distance of frequency is too short in a physical device. For example, it is assumed that the AP 121 and AP 122 affiliated with the AP MLD 120 operate on channel 120 at 5 GHz and channel 149 at 5 GHz, respectively. The AP 121 is transmitting a PPDU to an associated STA 111 while the AP 122 stays in a listen mode of clear channel assessment (CCA) status. The transmission power of the AP 121 operating on CH 120 at 5 GHz may cause leakage into channel 149 at 5 GHz (or vice-versa) due to short frequency distance. This causes the AP 122 to always consider the channel is busy and the AP 122 cannot transmit any frame to the corresponding STA 112.

Third, the coverage area and the supported links for the AP MLD 120 are limited due to collocated deployment of RF components. To support flexible coverage and coverage, the scalability of the AP MLD 120 is an issue to be addressed in the next generation of Wi-Fi technology.

Implementations of the present disclosure provide a solution for architecture of a distributed AP MLD so as to solve the above problems and one or more of other potential problems. According to the solution, an apparatus comprises at least two upper MAC sublayer function entities and at least one middle MAC sublayer function entity configured to be affiliated by at least one AP that has a lower MAC sublayer function entity. The at least one middle MAC sublayer function entity is configured to communicate with the at least two upper MAC sublayer function entity through a logical port.

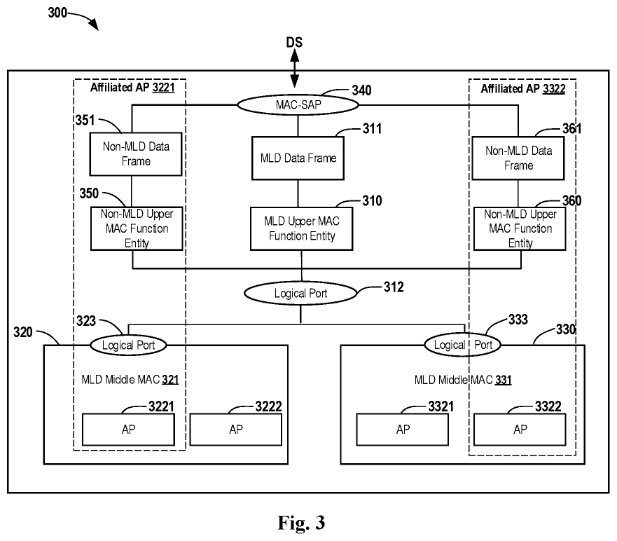

Hereinafter, principles of the present disclosure will be described with reference to FIGS. 3 to 7.

FIG. 3 illustrates an example apparatus 300 in accordance with some example implementations of the present disclosure. In some embodiments, the apparatus 300 may be implemented as a distributed AP MLD. The distributed AP MLD may increase throughput of a non-AP MLD communicating with the distributed AP MLD through aggregation of multiple links associated with multiple physical devices. In other embodiments, the apparatus 300 may be implemented as any other appropriate device. The scope of the present disclosure is not limited in this regard. Hereinafter, some embodiments of the present disclosure will be described taking the distributed AP MLD for example.

In embodiments where the apparatus 300 is implemented as a distributed AP MLD, a middle MAC sublayer function entity is also referred to as an MLD middle MAC sublayer function entity, and a lower MAC sublayer function entity is also referred to as an MLD lower MAC sublayer function entity.

As shown in FIG. 3, the apparatus 300 comprises an MLD upper MAC sublayer function entity 310, a first MLD middle MAC sublayer function entity 321 and a second MLD middle MAC sublayer function entity 331.

The first MLD middle MAC sublayer function entity 321 is configured to be affiliated by APs 3221 and 3222. Each of the APs 3221 and 3222 has an MLD lower MAC sublayer function entity. The second MLD middle MAC sublayer function entity 331 is configured to be affiliated by APs 3321 and 3322. Each of the APs 3321 and 3322 has an MLD lower MAC sublayer function entity.

The first MLD middle MAC sublayer function entity 321 is configured to communicate with the MLD upper MAC sublayer function entity 310 through a logical port 323 so as to implement functionalities of a MAC layer. The second MLD middle MAC sublayer function entity 331 is configured to communicate with the MLD upper MAC sublayer function entity 310 through a logical port 333 so as to implement functionalities of the MAC layer.

In some embodiments, the apparatus 300 may comprise a single MAC SAP 340 to logical link control (LLC). The MAC-SAP 340 may comprise one MAC data service.

In some embodiments, the first MLD middle MAC sublayer function entity 321 and the APs 3221 and 3222 may be deployed in a first physical device 320, as shown in FIG. 3. Each of the APs 3221 and 3222 may operate on a link. Similarly, the second MLD middle MAC sublayer function entity 331 and the APs 3321 and 3322 may be deployed in a second physical device 330 which is different from the first physical device 320, as shown in FIG. 3. Each of the APs 3321 and 3322 may operate on a link. The apparatus 300 may enable MLO over the physical devices 320 and 330.

In some embodiments, the first physical device 320 and the second physical device 330 may share the single MLD upper MAC sublayer function entity 310 when performing transmission of an MLD data frame 311 with a non-AP MLD. The APs 3221 and 3222 may share the first MLD middle MAC sublayer function entity 321. The APs 3321 and 3322 may share the second MLD middle MAC sublayer function entity 331.

In addition, the apparatus 300 further comprises a first non-MLD upper MAC sublayer function entity 350 and a second non-MLD upper MAC sublayer function entity 360.

In some embodiments, the first non-MLD upper MAC sublayer function entity 350 may be associated with the AP 3221 for transmission of a non-MLD data frame 351. The second non-MLD upper MAC sublayer function entity 360 may be associated with the AP 3322 for transmission of a non-MLD data frame 361. In some embodiments, the non-MLD data frames 351 and 361 may be data frames to or from a legacy (non-MLD) STA, or group addressed MLD data frames.

In this manner, the distributed AP MLD 300 may connect with a non-AP MLD with best links even if the non-AP MLD moves from one physical device to another, which will not result in throughput reduction. In addition, due to the coverage extension, the non-AP MLD can always be connected to the distributed AP MLD with a large area without placing a significant battery drain on the non-AP MLD and without incurring handoff cost of re-association or re-negotiation of security.

In some embodiments, the first non-MLD upper MAC sublayer function entity 350 may be configured to communicate with the lower MAC sublayer function entity of the AP 3221 through the logic port 323 using a tunnel which may be transparent to the first middle MAC sublayer function entity 321.

In some embodiments, the apparatus 300 may be implemented as a logical entity.

In some embodiments, the MLD upper MAC sublayer function entity 310 as well as the non-MLD upper MAC sublayer function entities 350 and 360 may be implemented in one of the physical devices 320 and 330.

In some embodiments, the MLD upper MAC sublayer function entity 310 as well as the non-MLD upper MAC sublayer function entities 350 and 360 may be implemented in a third device which is different from the physical devices 320 and 330. For example, the third device may comprise a network device.

In some embodiments, each of the physical devices 320 and 330 may be implemented as a plug-in physical device. In this way, the distributed AP MLD may provide good scalability to change the number of physical devices in order to meet the coverage or/and cost requirement. In general, the physical device will have lower cost than a legacy AP MLD with the same affiliated APs.

In some embodiments, the physical devices 320 and 330 may be transparent to the non-AP MLD communicating with the apparatus 300. After MLD setup or re-setup, one or more APs affiliated with one or more of the MLD middle MAC sublayer function entities 321 and 331 may be used for communication between the distributed AP MLD 300 and the non-AP MLD. Thus, the distributed AP MLD may be well compatible with legacy non-AP MLD as the physical devices 320 and 330 are transparent to the non-AP MLD.

It is to be understood that the number of the MLD middle MAC sublayer function entities in the apparatus 300, the number of the APs affiliated with the MLD middle MAC sublayer function entities 321 and 331 and the number of the non-MLD upper MAC sublayer function entities as shown in FIG. 3 are only for the purpose of illustration without suggesting any limitations. The apparatus 300 may include any suitable number of MLD middle MAC sublayer function entities, any suitable number of APs and any suitable number of non-MLD upper MAC sublayer function entities adapted for implementing embodiments of the present disclosure.

In some embodiments, the MLD upper MAC sublayer function entity 310 may comprise common functions across all the MLD middle MAC sublayer function entities 321 and 331.

In some embodiments, a TID may be mapped to a set of multiple links, allowing traffic with that TID to be transmitted using any link in this set. In this way, a higher rate of traffic with that TID may be handled, and a congested queue for that TID will be flushed faster. The MLD upper MAC sublayer function entity 310 on the transmitter side may be configured to collect at least one of the following: TID-to-link mapping, or queue status of the TID. For example, the MLD upper MAC sublayer function entity 310 on the transmitter side may be configured to collect the queue status of the TID which is stored locally. Additionally or alternatively, the MLD upper MAC sublayer function entity 310 on the transmitter side may be configured to collect the queue status of the TID from the MLD middle MAC sublayer function entities 321 and 331. In turn, the MLD upper MAC sublayer function entity 310 may be configured to select one of the MLD middle MAC sublayer function entities 321 and 331 for transmission or retransmission of traffic with the TID based on at least one of the following: TID-to-link mapping, or queue status of the TID.

In some embodiments, unlike the legacy AP MLD, the block Ack scoreboarding maintenance at the MLD upper MAC sublayer function entity 310 may be based on collaboration with at least one of the MLD middle MAC sublayer function entities 321 and 331. In such embodiments, the MLD upper MAC sublayer function entity 310 may be configured to obtain a block Ack status of MPDUs from the first MLD middle MAC sublayer function entity 321 and schedule retransmission of the MPDUs across the MLD middle MAC sublayer function entities 321 and 331 based on the block acknowledgment status.

In some embodiments, the MLD upper MAC sublayer function entity 310 may be configured to provide the block Ack status to the second MLD middle MAC sublayer function entity 331.

In some embodiments, the first MLD middle MAC sublayer function entity 321 may comprise common functions across all the subordinate links.

In some embodiments, the first MLD middle MAC sublayer function entity 321 may be configured to provide capability information and operation parameters of each of the links associated with the APs 3221 and 3222 to the MLD upper MAC sublayer function entity 310.

Alternatively, in some embodiments, the apparatus 300 may further comprises a station management entity (SME) which is not shown in FIG. 3. The SME, the MLD upper MAC sublayer function entity 310, the non-MLD upper MAC sublayer function entities 350 and 360 may be implemented in a single physical device within the apparatus 300.

In some embodiments, the first MLD middle MAC sublayer function entity 321 may be configured to provide capability information and operation parameters of each of the links associated with the APs 3221 and 3222 to the SME.

In some embodiments, at least one of the MLD upper MAC sublayer function entity 310 and the SME may be configured to determine whether the first MLD middle MAC sublayer function entity 321 is eligible based on the capability information and operation parameters. If the first MLD middle MAC sublayer function entity 321 is eligible, at least one of the MLD upper MAC sublayer function entity 310 and the SME may be configured to activate the first MLD middle MAC sublayer function entity 321 as well as the APs 3221 and 3222 for MLO based on the capability information and the operation parameters. After activation, at least one of the MLD upper MAC sublayer function entity 310 and the SME may be configured to manage the links associated with the APs 3221 and 3222 like the legacy AP (e.g., to enable or disable the links).

On the other hand, if the first MLD middle MAC sublayer function entity 321 is not eligible, at least one of the MLD upper MAC sublayer function entity 310 and the SME may be configured to deactivate the first MLD middle MAC sublayer function entity 321 as well as the APs 3221 and 3222 for MLO based on the capability information and the operation parameters.

In some embodiments, the logical port 323 may be configured to implement a transport protocol used for exchange of information between the MLD upper MAC sublayer function entity 310 and the first MLD middle MAC sublayer function entity 321. The information may comprise at least one of the following: management information, control information, configuration information or data information.

In some embodiments, the exchange of information between the MLD upper MAC sublayer function entity 310 may be performed through the logical port 323 and a logical port 312 in the MLD upper MAC sublayer function entity 310.

In some embodiments, the first MLD middle MAC sublayer function entity 321 may be configured to buffer a MPDU from the MLD upper MAC sublayer function entity 310 for transmission or retransmission within the physical device 320.

In some embodiments, the MLD upper MAC sublayer function entity 310 may not be configured to buffer the MPDU locally. In such embodiments, the first MLD middle MAC sublayer function entity 321 may be configured to provide the buffered MPDU to the MLD upper MAC sublayer function entity 310 for transmission or retransmission across the physical devices 320 and 330.

In some embodiments, the first MLD middle MAC sublayer function entity 321 may be configured to select one or more of the links 3221 and 3222 for transmission or retransmission of a buffered MPDU based on at least one of the following:
setup statuses of the links associated with the APs 3221 and 3222,
a link indication in the MPDU,
a TID of the MPDU,
buffer statuses of the TID on the links associated with the APs 3221 and 3222,
queue statuses of the TID on the links associated with the APs 3221 and 3222, or
TID-to-link mapping obtained from the MLD upper MAC sublayer function entity 310.

In some embodiments, the first MLD middle MAC sublayer function entity 321 may be configured to obtain a block Ack status of MPDUs from the link 3221 and provide the block Ack status to the link 3222 for retransmission of the MPDUs through the link 3222.

In some embodiments, the first MLD middle MAC sublayer function entity 321 may be configured to provide the block Ack status to the MLD upper MAC sublayer function entity 310.

In some embodiments, each of the MLD lower MAC sublayer function entities of the APs 3221 and 3222 may be configured to implement most functions of the lower MAC sublayer 220 in the legacy AP MLD 120 with minor enhancements. For example, each of the MLD lower MAC sublayer function entities of the APs 3221 and 3222 may be configured to maintain the block Ack status in collaboration with the first MLD middle MAC sublayer function entity 321.

It shall be understood that the functions of an MLD middle MAC sublayer function entity have been described by taking the first MLD middle MAC sublayer function entity 321 for example. The second MLD middle MAC sublayer function entity 331 may have the same functions as the first MLD middle MAC sublayer function entity 321. For brevity, details of the functions of the second MLD middle MAC sublayer function entity 331 are omitted.

Similarly, the MLD lower MAC sublayer function entities of the APs 3321 and 3322 may have the same functions as the MLD lower MAC sublayer function entities of the APs 3221 and 3222. For brevity, details of the functions of the MLD lower MAC sublayer function entities of the APs 3321 and 3322 are omitted.

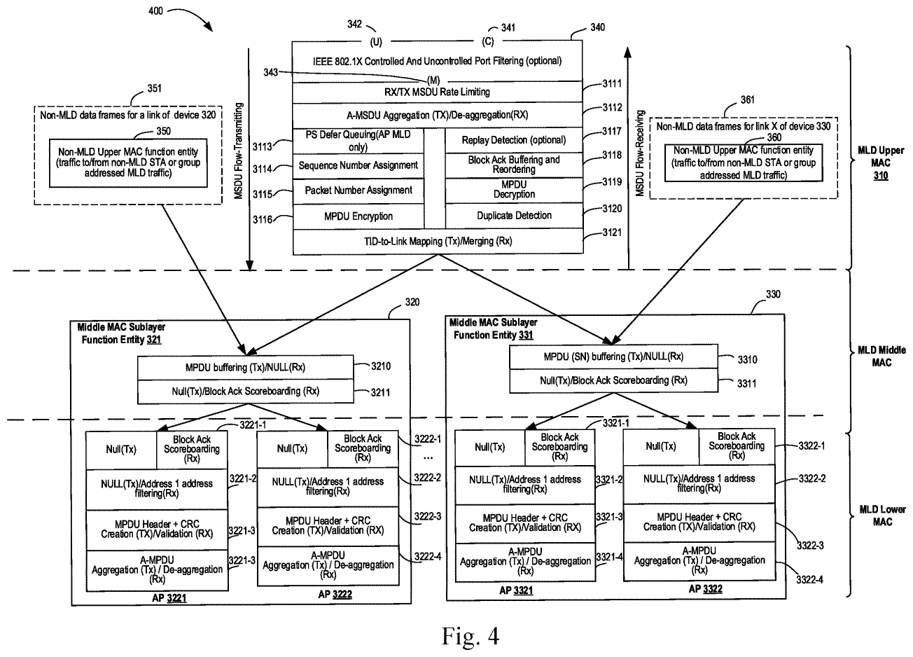

FIG. 4 illustrates an example of data plane architecture 400 of a MAC layer for the distributed AP MLD 300 in accordance with some example implementations of the present disclosure.

As shown in FIG. 4, the distributed AP MLD 300 comprises the MLD upper MAC sublayer function entity 310, the first MLD middle MAC sublayer function entity 321, the second MLD middle MAC sublayer function entity 331, the non-MLD upper MAC sublayer function entity 350 and the non-MLD upper MAC sublayer function entity 360.

In addition, the distributed AP MLD 300 also comprises an IEEE 802.1X controlled and uncontrolled port filtering port 340. The IEEE 802.1X controlled and uncontrolled port filtering port 340 comprises an IEEE 802.1X controlled port (C) 341 and an IEEE 802.1X uncontrolled port (U) 342. The IEEE 802.1X controlled and uncontrolled port 340 communicates with the MLD upper MAC sublayer 310 through a single MAC-SAP 343. The functions of the IEEE 802.1X controlled and uncontrolled port filtering port 340 are the same as that of the IEEE 802.1X controlled and uncontrolled port filtering port 230 in FIG. 2. Thus, details of the functions are omitted for brevity.

The MLD upper MAC sublayer 310 comprises an RX/TX MSDU rate limiting block 3111, an A-MSDU aggregation or de-aggregation block 3112, a PS defer queueing block 3113, a sequence number (SN) assignment block 3114, a packet number (PN) assignment block 3115, an MPDU encryption block 3116, a replay detection block 3117 (which is optional), a block acknowledgment (Ack) buffering and reordering block 3118, an MPDU decryption block 3119, a duplicate detection block 3120, and a traffic identifier (TID)-to-link mapping or merging block 3121.

The functions of the blocks 3111 to 3117, 3119 and 3120 are the same as those of the blocks 2111 to 2117, 2119 and 2120 in FIG. 2. For brevity, details of the functions of the blocks 3111 to 3117, 3119 and 3120 are omitted.

The first MLD middle MAC sublayer 321 comprises an MPDU buffering block 3210 and a block Ack scoreboarding block 3211.

The MPDU buffering block 3210 may be configured to buffer a MPDU from the MLD upper MAC sublayer function entity 310 for transmission or retransmission within the physical device 320.

The MLD lower MAC sublayer of the AP 3221 comprises a block Ack scoreboarding block 3221-1, an address filing block 3221-2, an MPDU header and CRC creation or validation block 3221-3 and an A-MSDU aggregation or de-aggregation block 3221-4. The functions of the blocks 3221-2 to 3221-4 are the same as those of the blocks 2211 to 2213. For brevity, details of the functions of the blocks 3221-2 to 3221-4 are omitted.

The MLD lower MAC sublayer of the AP 3222 comprises a block Ack scoreboarding block 3222-1, an address filing block 3222-2, an MPDU header and CRC creation or validation block 3222-3 and an A-MSDU aggregation or de-aggregation block 3222-4. The functions of the blocks 3222-2 to 3222-4 are the same as those of the blocks 2211 to 2213. For brevity, details of the functions of the blocks 3222-2 to 3222-4 are omitted.

The second MLD middle MAC sublayer 331 comprises an MPDU buffering block 3310 and a block Ack scoreboarding block 3311.

The MPDU buffering block 3310 may be configured to buffer a MPDU from the MLD upper MAC sublayer function entity 310 for transmission or retransmission within the physical device 330.

The MLD lower MAC sublayer of the AP 3321 comprises a block Ack scoreboarding block 3321-1, an address filing block 3321-2, an MPDU header and CRC creation or validation block 3321-3 and an A-MSDU aggregation or de-aggregation block 3321-4. The functions of the blocks 3321-2 to 3321-4 are the same as those of the blocks 2211 to 2213. For brevity, details of the functions of the blocks 3321-2 to 3321-4 are omitted.

The MLD lower MAC sublayer of the AP 3322 comprises a block Ack scoreboarding block 3322-1, an address filing block 3322-2, an MPDU header and CRC creation or validation block 3322-3 and an A-MSDU aggregation or de-aggregation block 3322-4. The functions of the blocks 3322-2 to 3322-4 are the same as those of the blocks 2211 to 2213. For brevity, details of the functions of the blocks 3322-2 to 3322-4 are omitted.

In some embodiments, during transmission, MSDUs from the MAC-SAP 343 goes through the processes shown in the left hand side of FIG. 4.

The upper MAC sublayer function entity 310 is configured to forward the MPDU down to one of the MLD middle MAC sublayer function entities 321 and 331 through the TID-to-link mapping process. Hereinafter, some embodiments will be described by taking the MLD middle MAC sublayer function entity 321 for example.

Based on the implementation of the MLD middle MAC sublayer function entity 321, in some embodiments, the MLD middle MAC sublayer function entity 321 may forward the MPDUs from the MLD upper MAC sublayer function entity 310 down to one of the MLD lower MAC sublayer function entities of the APs 3221 and 3222 through a further TID-to-link mapping process. In other embodiments, the MLD middle MAC sublayer function entity 321 may directly forward the MPDUs down to one of the MLD lower MAC sublayer function entities of the APs 3221 and 3222 as indicated by the MPDUs.

Upon receiving the MPDUs, the MLD lower MAC sublayer function entity of the AP 3221 or 3222 may deliver the MPDUs to the corresponding PHY SAP after certain processing, such as address filtering or aggregation of MPDUs.

In some embodiments, during reception, MPDUs originating from different PHY SAPs first go through the MLD lower MAC sublayer function entity of the AP 3221 or 3222, followed by a merging process in the TID-to-link mapping or merging block 3121 in the MLD upper MAC sublayer function entity 310. Then, the MPDUs go through the process in the right-hand side of FIG. 4. One or more MSDUs are delivered to the MAC-SAP 343 or via the DSAF to the DS.

In some embodiments, optionally, the reception of the MPDUs may be transparent to the MLD middle MAC sublayer function entities 321 and 331.

In some embodiments, block Ack scoreboarding may be maintained on each of the MLD upper MAC sublayer function entity 310, the MLD middle MAC sublayer function entities 321 and 331 as well as the MLD lower MAC sublayer function entities of the APs 3221 and 3222.

In some embodiments, the block Ack scoreboarding block 3118 in the MLD upper MAC sublayer function entity 310 manages the block Ack status of MPDUs of a block Ack session that are received on any setup link. The MLD upper MAC sublayer function entity 310 may receive the block Ack status of the MPDUs from its subordinate MLD middle MAC sublayer function entities 321 and 331.

In some embodiments, in collaboration with the MLD lower MAC sublayer function entities of the APs 3221 and 3222, the block Ack scoreboarding block 3221-1 in the MLD middle MAC sublayer function entity 321 is configured to manage the block Ack status of MPDUs of a block Ack session that are received on any subordinate setup link. The MLD middle MAC sublayer function entity 321 in the physical device 320 may receive the Block Ack status of the MPDUs from its subordinate MLD lower MAC sublayer function entities of the APs 3221 and 3222 or from the physical device 330.

In some embodiments, the block Ack scoreboarding block 3221-1 in the MLD lower MAC sublayer function entity of the AP 3221 is configured to manage the block Ack status of the MPDUs of a block Ack session that are received on this link. The MLD lower MAC sublayer function entity of the AP 3221 associated with one link may receive the block Ack status of the MPDUs from the other link affiliated with the physical device 320.

In some embodiments, retransmission of an MPDU may be performed as below.

In one embodiment, if a NACK is received for transmission of the MPDU on a setup link associated with the MLD lower MAC sublayer function entity of the AP 3221, the MLD lower MAC sublayer function entity of the AP 3221 may re-transmit the MPDU on the setup link based on the contents in the block Ack scoreboarding block 3221-1.

In another embodiment, the MLD middle MAC sublayer function entity 321 may schedule retransmission of MPDUs across the links affiliated with the physical device 320 based on the contents in the block Ack scoreboarding block 3211.

In a further embodiment, the MLD upper MAC sublayer function entity 310 may schedule retransmission of MPDUs across the physical devices 320 and 330 based on the contents in the block Ack scoreboarding block 3118.

For the data plane architecture 400, the distributed AP MLD 300 may transmit the non-MLD data frames by an affiliated AP (such as the AP 3221) using a dedicated non-MLD upper sublayer function entity of the affiliated AP. The non-MLD upper sublayer function entity connects the MLD middle MAC sublayer function entity 321 affiliated by the AP through the logical port. The MLD middle MAC sublayer function entity 321 may schedule the non-MLD data frames to be transmitted through corresponding link of the affiliated AP.

When the distributed AP MLD 330 receives a non-MLD data packet on a link, the MLD low MAC sublayer function entity associated with the link may decode the data packet and forward the corresponding MPDU to the MLD middle MAC sublayer function entity (for example, the MLD middle MAC sublayer function entity 321). After that, the MLD middle MAC sublayer function entity 321 may transmit the received MPDU to the non-MLD MAC sublayer function entity 350 of the link for further processing.

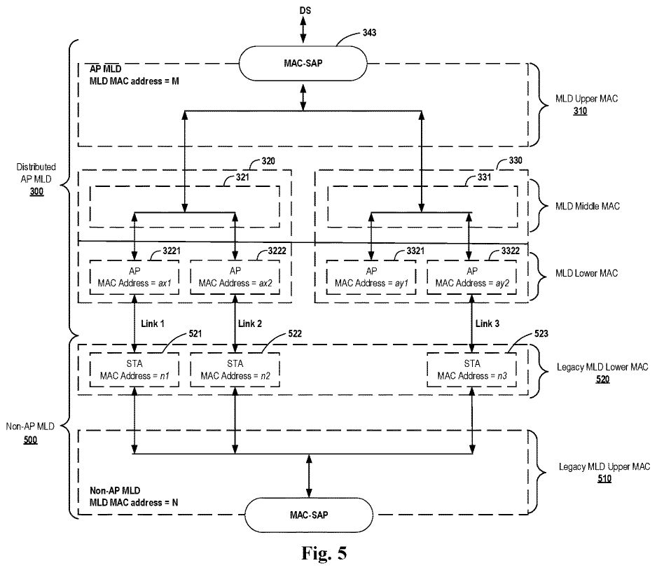

FIG. 5 illustrates an example of MLO between the distributed AP MLD 300 in accordance with some example implementations of the present disclosure and a non-AP MLD 500.

As shown in FIG. 5, the distributed AP MLD 300 comprises the MLD upper MAC sublayer function entity 310, the first MLD middle MAC sublayer function entity 321, and the second MLD middle MAC sublayer function entity 331. Because the non-MLD upper MAC sublayer function entity 350 and the non-MLD upper MAC sublayer function entity 360 are not related to MLO, the entities 350 and 360 are not shown in FIG. 5.

The embodiments of the entities 310, 321 and the 331 which have been described with reference to FIGS. 3 and 4 are also applied to the distributed AP MLD 300 in FIG. 5. The details of the embodiments are omitted for brevity.

The non-AP MLD 500 comprises a legacy MLD upper MAC sublayer function entity 510 and a legacy MLD lower MAC sublayer function entity 520. The legacy MLD lower MAC sublayer function entity 520 is affiliated with STAS 521, 522 and 523.

In this example, the distributed AP MLD 300 is configured with MLD MAC address M, and the non-AP MLD is configured with MLD MAC address N.

After multi-link setup, three links are established between the non-AP MLD 500 and the distributed AP MLD 300. That is, a link 1 is established between the AP 3221 and non-AP STA 521, a link 2 is established between the AP 3222 and the non-AP STA 522, and a link 3 is established between the AP 3322 and the non-AP STA 523. The distributed AP MLD 300 may increase throughput of the non-AP MLD 500 through aggregation of the three links associated with the physical devices 320 and 330.

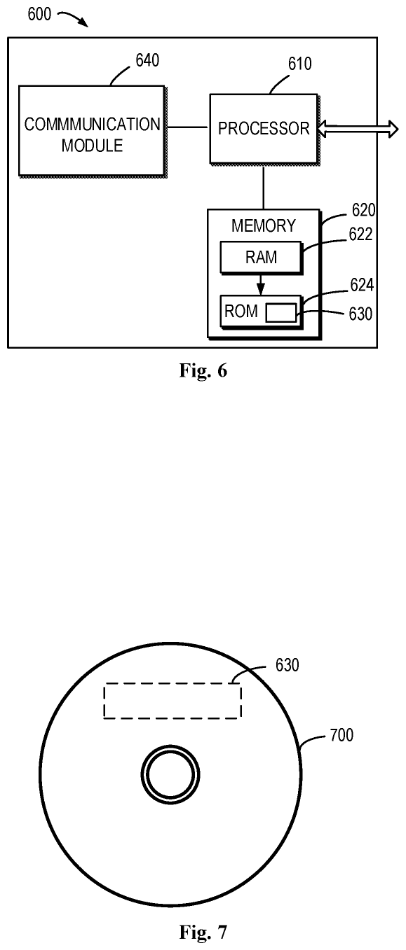

FIG. 6 is a simplified block diagram of a device 600 that is suitable for implementing embodiments of the present disclosure. The device 600 may be provided to implement the communication device, for example, the apparatus 300 as shown in FIG. 3. As shown, the device 600 includes one or more processors 610, one or more memories 620 coupled to the processor 610, and one or more communication modules 640 coupled to the processor 610.

The communication module 640 is configured for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions, e.g., computer program 630 may be stored in the memory 620, e.g. ROM 624. The processor 610 may perform any suitable actions and processing by loading the program 630 into the RAM 622.

The embodiments of the present disclosure may be implemented by means of the instructions, e.g., computer program 630 so that the device 600 may perform any process of the disclosure as discussed with reference to FIGS. 3 to 5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, for the device to carry out the methods as described above with reference to FIGS. 3 and 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

List of acronyms and abbreviations

| | |
|---|---|
| A-MPDU | Aggregation of MAC Data Unit |
| AP | Access Point |
| AR | Augmented Reality |
| BIGTK | Beacon Integrity Group Temporal Key |
| CTS | Clear To Send |
| DS | Distributed System |
| DSAF | Distribution System Access Function |
| GTK | Group Temporal Key |
| IGTK | Integrity Group Temporal Key |
| LLC | Logical Link Control |
| MAC | Medium Access Control |
| MLD | Multi-Link Device |
| MLO | Multi-Link Operation |
| MPDU | MAC Packet Data Unit |
| NDP | Null Data Packet |
| RTS | Request To Send |
| RX | Receiver |
| SAP | Service Access Point |
| MSDU | MAC Service Daya Unit |
| SN | Sequence Number |
| SME | Station Management Entity |
| STA | STAtion |
| Tx | Transceiver |
| PMK | Pairwise Master Key |
| PMKSA | Pairwise Master Key Security Association |
| PN | Packet Number |
| PTKSA | Pairwise Transient Key Security Association |
| TID | Traffic Identifier |
| VR | Virtual Reality |
| XR | Extended reality |

1-25. (canceled)

26. An apparatus, comprising:
at least one processor; and
at least one memory storing instructions that, when executed by the at least one processor, cause the apparatus at least to:
implement at least two upper medium access control, MAC, sublayer function entities; and
affiliate at least one middle MAC sublayer function entity with at least one access point, AP, that has a lower MAC sublayer function entity, wherein the at least one middle MAC sublayer function entity communicates with the at least two upper MAC sublayer function entities through a logical port.

27. The apparatus of claim 26, wherein the at least two upper MAC sublayer function entities comprise a multi-link device, MLD, upper MAC sublayer function entity and at least one non-MLD upper MAC sublayer function entity.

28. The apparatus of claim 26, wherein the at least one non-MLD upper MAC sublayer function entity comprises a first non-MLD upper MAC sublayer function entity configured to be associated with a first AP and a first lower MAC sublayer function entity of the first AP, the first AP being affiliated with a first middle MAC sublayer function entity.

29. The apparatus of claim 28, wherein the first non-MLD upper MAC sublayer function entity is configured to communicate with the first lower MAC sublayer function entity through the logic port using a tunnel which is transparent to the at least one middle MAC sublayer function entity.

30. The apparatus of claim 27, wherein the MLD upper MAC sublayer function entity is configured to:
select one of the at least one middle MAC sublayer function entity for transmission or retransmission of traffic with a traffic identifier, TID, based on at least one of the following: TID-to-link mapping, or queue status of the TID.

31. The apparatus of claim 27, wherein the middle MAC sublayer function entity comprises a first middle MAC sublayer function entity configured to be affiliated by at least one first AP and a second middle MAC sublayer function entity configured to be affiliated by at least one second AP; and
wherein the first middle MAC sublayer function entity and the at least one first AP are deployed in a first physical device, the second middle MAC sublayer function entity and the at least one second AP are deployed in a second physical device which is different from the first physical device, the first and second physical devices being included in the apparatus.

32. The apparatus of claim 31, wherein the MLD upper MAC sublayer function entity is configured to:
obtain a block acknowledgment status of MAC packet data units, MPDUs, from the first middle MAC sublayer function entity; and
schedule retransmission of the MPDUs across the at least one middle MAC sublayer function entity based on the block acknowledgment status.

33. The apparatus of claim 32, wherein the MLD upper MAC sublayer function entity is further configured to:
provide the block acknowledgment status to the second middle MAC sublayer function entity.

34. The apparatus of claim 31, wherein
each of the at least one first AP is configured to operate on a link and the first middle MAC sublayer function entity is configured to provide capability information and operation parameters of each of at least one link to the MLD upper MAC sublayer function entity; and
the MLD upper MAC sublayer function entity is configured to perform at least one of the following:
activating the first middle MAC sublayer function entity and the at least one first AP for multi-link operation based on the capability information and the operation parameters,
deactivating the first middle MAC sublayer function entity and the at least one first AP for the multi-link operation based on the capability information and the operation parameters, or
managing the first middle MAC sublayer function entity and the at least one first AP for the multi-link operation based on the capability information and the operation parameters.

35. The apparatus of claim 34 wherein the at least two upper MAC sublayer function entities and the SME are implemented:
in at least one of the first and second physical devices; or
in a third physical device which is different from the first and second physical devices, the third physical device being included in the apparatus.

36. The apparatus of claim 31, wherein
each of the at least one first AP is configured to operate on a link and the first middle MAC sublayer function entity is configured to provide capability information and operation parameters of each of at least one link to a station management entity, SME; and
the SME is configured to perform at least one of the following:
activating the first middle MAC sublayer function entity and the at least one first AP for multi-link operation based on the capability information and the operation parameters,
deactivating the first middle MAC sublayer function entity and the at least one first AP for the multi-link operation based on the capability information and the operation parameters, or
managing the first middle MAC sublayer function entity and the at least one first AP for the multi-link operation based on the capability information and the operation parameters.

37. The apparatus of claim 31, wherein
each of the at least one first AP is configured to operate on a link and the first middle MAC sublayer function entity is configured to:
select one or more of the at least one link for transmission or retransmission of a MAC packet data unit, MPDU, based on at least one of the following:
a setup status of the at least one link
a link indication in the MPDU,
a traffic identifier, TID, of the MPDU,
a buffer status of the TID on the at least one link,
a queue status of the TID on the at least one link, or
TID-to-link mapping obtained from the MLD upper MAC sublayer function entity.

38. The apparatus of claim 31, wherein each of the at least one first AP is configured to operate on a link and the first middle MAC sublayer function entity is configured to:
obtain, from a first link, a block acknowledgment status of MAC packet data units, MPDUs; and
provide the block acknowledgment status to a second link for retransmission of the MPDUs through the second link.

39. The apparatus of claim 27, wherein the at least one middle MAC sublayer function entity is configured to:
buffer a MAC packet data unit, MPDU, from the MLD upper MAC sublayer function entity for transmission or retransmission within the at least one middle MAC sublayer function entity.

40. The apparatus of claim 39, wherein the at least one middle MAC sublayer function entity is further configured to:
provide the buffered MPDU to the MLD upper MAC sublayer function entity for transmission or retransmission across the at least one middle MAC sublayer function entity.

41. The apparatus of claim 26, wherein the at least two upper MAC sublayer function entities and the at least one middle MAC sublayer function entity are implemented in a single physical device, the single physical device being included in the apparatus.

42. The apparatus of claim 26, wherein the at least two upper MAC sublayer function entities are implemented in a third physical device, and the at least one middle MAC sublayer function entity is implemented in a fourth physical device which is different from the third physical device, the third and fourth physical devices being included in the apparatus.

43. The apparatus of claim 40, wherein at least one of the third and fourth physical devices are pluggable.

44. A method, comprising:
implementing at least two upper medium access control, MAC, sublayer function entities; and
affiliating at least one middle MAC sublayer function entity with at least one access point, AP, that has a lower MAC sublayer function entity, wherein the at least one middle MAC sublayer function entity communicates with the at least two upper MAC sublayer function entities through a logical port.

45. A computer readable medium comprising program instructions for causing an apparatus to perform the following:
implementing at least two upper medium access control, MAC, sublayer function entities; and
affiliating at least one middle MAC sublayer function entity with at least one access point, AP, that has a lower MAC sublayer function entity, wherein the at least one middle MAC sublayer function entity communicates with the at least two upper MAC sublayer function entities through a logical port.
